(19) United States
(12) Patent Application Publication
(10) Pub. No.: US 2006/0091751 A1
(43) Pub. Date: May 4, 2006

(54) Universal mount alternator housing

(75) Inventor: Jeffrey M. Gaul, El Paso, TX (US)

Correspondence Address: FITCH EVEN TABIN AND FLANNERY, 120 SOUTH LA SALLE STREET, SUITE 1600, CHICAGO, IL, 60603-3406, US

(73) Assignee: Autotronic Controls Corporation

(21) Appl. No.: 10/978,739

(22) Filed: Nov. 1, 2004

(51) Int. Cl. H02K 15/00; H02K 5/00

(52) U.S. Cl. 310/91; 310/89; 310/42; 248/637

(57) ABSTRACT

An alternator and brackets having cooperating structure for selectively securing the brackets to the alternator such that the brackets are aligned with mounts on the engine for securing the alternator. The slots may have a larger portion and a smaller portion and the brackets may a stem and wings on a foot portion such that the wings are secured within the larger portion. The foot portions may be slid or otherwise fit into the slots so as to be selectively positioned on an exterior surface of a housing of the alternator. Brackets with a variety of configurations may be provided so that the alternator and brackets may be secured in a variety of different orientations relative to the engine.

### FIELD OF THE INVENTION

The invention relates to an alternator and, in particular, to an alternator housing configured such that the alternator may be installed in a variety of vehicles.

### BACKGROUND OF THE INVENTION

Currently, hundreds of vehicle makes and models are currently being manufactured that are considered full production vehicles. Some manufactures may have similar engine compartments, engines, or engine components for similar vehicles produced on an identical chassis but carrying different nameplates and body panels. Despite this fact, many of the vehicles currently being produced are manufactured with components that are not designed to be interchangeable between vehicles.

Some components produced for one type of vehicle may be installed in a different vehicle. However, most components are designed to be located in a particular space within an engine compartment. Accordingly, a component that is substituted for the original component often must be mountable within that same space. Because there is such a variety of designs of vehicles, it is not common for components to be easily interchanged.

This is particularly true in performance vehicles. That is, many performance vehicles, such as exotics or two-seat mid-engine sports cars, have limited space in the engine compartment, and the engine and vehicle were built to accommodate each other with little wasted or spare space. When high-performance is desired from a vehicle, original components are often replaced with high-performance components. Furthermore, vehicles that have been after-market modified often have add-on components or systems, such as a Nitrous Oxide system, located within the engine compartment that require space and do not necessarily allow for space-wasting or cumbersome mounting of components.

In order to make a component that fits in the space designed for a particular component, the mountings for the component are often designed specifically for that component. In other words, that component may not fit in another vehicle of different make or model because the mounting fixtures the component is provided with may not match the reciprocal mounting fixtures provided by the other vehicle. Though this allows the component to be compactly mounted in the vehicle for which it is designed, it also requires any replacement to be manufactured to also fit on the mounting fixtures of the vehicle and in the space originally provided.

Typically, this problem has been addressed by manufacturing separate after-market components, each designed to fit a separate major make and model of vehicle. That is, the housing of the component is typically provided with a variety of designs, one tailored for each major make and model of vehicle, while the inner workings of each design are generally identical.

For the retailer, this has a number of effects. When a vehicle needs a new component such as an alternator, it is not typical that the owner of the vehicle can wait for several weeks to receive the specially designed alternator from the automobile manufacturer or from an original equipment manufacturer. Accordingly, parts stores, as well as service departments at automobile dealers, must choose between carrying alternators for only a few makes and models and resorting to parts distributors for the majority of their requirements, or must devote extensive shelf and/or storage space to the myriad of alternators that may be required by customers.

Accordingly, there has been a need to minimize the amount of individual manufacturing required for various vehicle makes and models.

### SUMMARY OF THE INVENTION

In accordance with one aspect of the present invention, an alternator for use with an internal combustion engine is disclosed including a rotor, a stator, a housing, and at least one bracket selectively securable to the housing, wherein the housing and the bracket are provided with cooperating structures for securing the bracket to the housing. The cooperating structures may include a slot and a foot. The bracket may include the foot, and an exterior surface of the housing may include a series of slots for selectively receiving the foot to secure the bracket to the housing. The slots may be positioned every 30 degrees around the surface of the housing. Each bracket may include two feet for being received in two slots of the housing, and the two feet may be received in adjacent slots of the housing.

Each slot may have an upper portion and a lower portion larger than the upper portion, each foot may have a wing portion larger than a stem portion, and the wing portion may be received in the larger, lower portion of the slot. Each foot may be integral with the bracket. Each foot may be secured to the bracket by a set screw. Each bracket may include a bolt hole for securing the bracket to the engine. The bolt hole may be aligned with a central axis of the alternator. The cooperating structures may be frictionally secured, and may be press-fit.

In accordance with a further aspect of the present invention, a kit for installing an alternator used with an internal combustion engine is disclosed including an alternator having a housing, radially located slots formed in an outer surface of the housing and having an upper portion and a lower portion larger than the upper portion and positioned closer to a central axis of the alternator, brackets including structure receivable in one or more slots, wherein the brackets may be selectively secured in the slots, and the secured brackets may be secured to mounts provided on the engine for securing the alternator thereto. The brackets may include a set of brackets configured for securing to the engine in a first orientation. The brackets may include at least a second set of brackets configured for securing to a different internal combustion engine in at least a second orientation.

In accordance with an additional aspect of the present invention, a method for installing an alternator used with an internal combustion engine of a vehicle is disclosed including the steps of providing an internal combustion engine with mounts for receiving at least one securing bolt, providing an alternator with a housing, providing slots on an outer surface of the housing, selecting at least one bracket with a bolt hole, inserting a portion of each bracket in at least one of the slots, securing the bracket to the at least one slot so that the bolt holes are aligned with the mounts of the engine, and securing bolts in the bolt holes of the brackets and the mounts. The method may further include the step of identifying the make and model of the vehicle, and the step of selecting the bracket may be based on the make and model.

In this manner, the present invention allows an auto parts store or automobile service department to carry a single alternator and an array of brackets designed for individual makes and models of vehicles. This allows an end user or consumer to install an alternator in the precise desired location, while also allowing the parts store, for instance, to drastically reduce volume of expensive stock on hand, and to drastically reduce the shelf and storage space required for the parts.

### BRIEF DESCRIPTION OF THE DRAWINGS

In the drawings, FIG. 1 is a partially exploded perspective view of an alternator including features of the present invention and a first form for mounting brackets;

FIG. 2 is a fragmentary partially exploded perspective view of the alternator including features of the present invention and a second form for mounting brackets;

FIG. 3 is a front elevational fragmentary partial cross-sectional view of the alternator and mounting brackets of FIG. 2;

FIG. 4 is a representational view of an engine with the alternator mounted thereto in a first arrangement;

FIG. 5 is a representational view of an engine with the alternator mounted thereto in a second arrangement;

FIG. 6 is a front elevational view of a first configuration for a mounting bracket;

FIG. 7 is a front elevational view of a second configuration for a mounting bracket;

FIG. 8 is a front elevational view of a third configuration for a mounting bracket;

FIG. 9 is a front elevational fragmentary cross-sectional view of the alternator and mounting brackets of FIG. 1; and

FIG. 10 is a front elevational fragmentary partial cross-sectional view of the alternator and a third form of a mounting bracket.

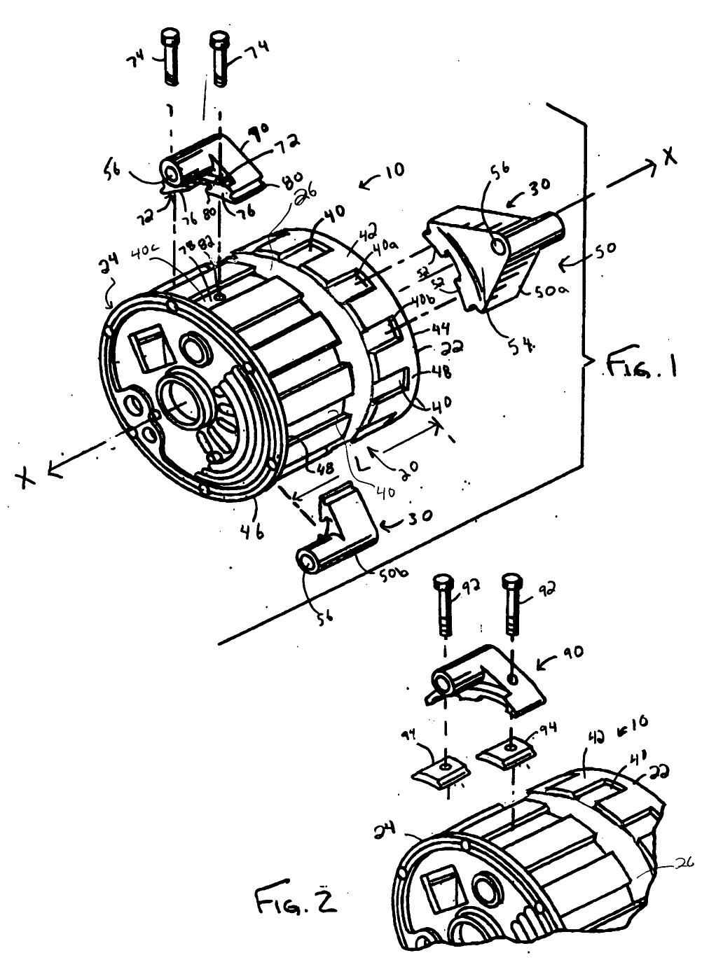

### DESCRIPTION OF THE PREFERRED EMBODIMENTS

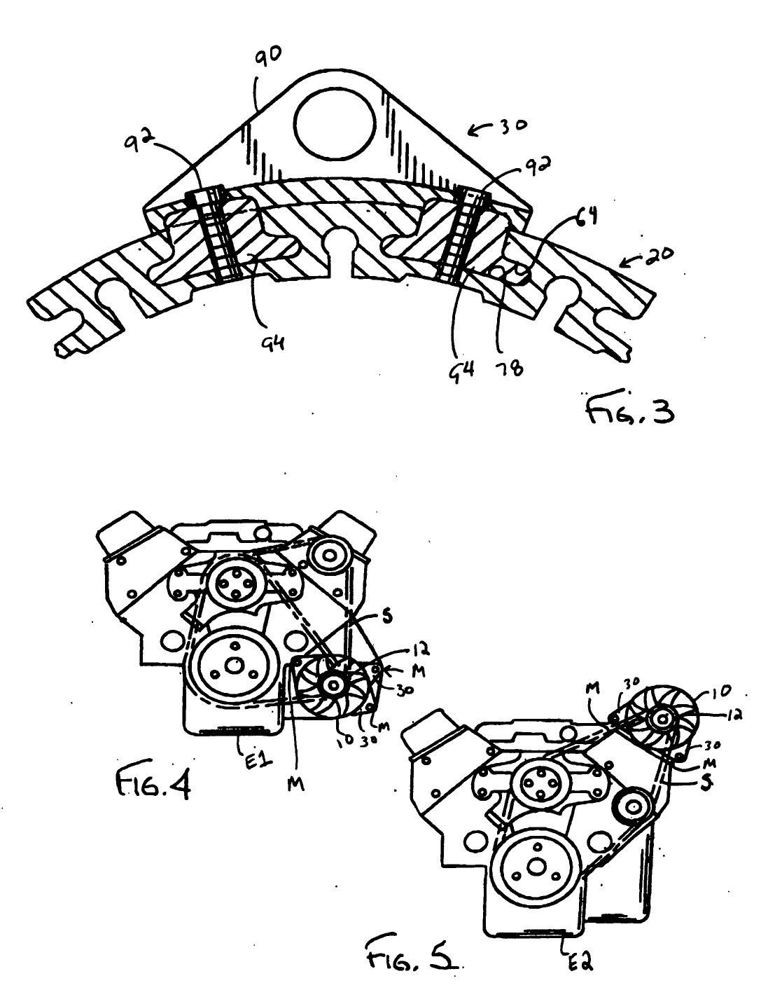

Referring initially to FIG. 1, an alternator 10 for use with an internal combustion engine E is depicted having a housing 20 including a front cover 22, a back cover 24, and a stator 26. The alternator 10 further includes a rotor (not shown), electrical leads (not shown), and a pulley 12 (see FIGS. 4 and 5), as is known in the art. It should be noted that the stator 26 may be covered by a splitter or cover (not shown) positioned between the front and back covers 22, 24, as will be described below.

As can be seen in FIGS. 4 and 5, the alternator 10 may be mounted to a first engine E1 in a first orientation and may be mounted to a second engine E2 in a second orientation. The orientation with which the alternator 10 is mounted to the engine E is dependent on how the manufacturer of the engine E and/or vehicle (not shown) designed the vehicle. The engine E is provided with mounts M for attaching the alternator 10 to the engine E so that the pulley 12 of the alternator 10 is engaged with a serpentine belt S, as is known in the art. The configuration of the mounts M is selected based upon the space provided within the engine compartment of the vehicle and varies from vehicle to vehicle.

Accordingly, the alternator 10 of the present invention is provided with the housing 20 and a variety of brackets 30 mountable to the housing 20 so that the alternator 10 may be mounted in a variety of orientations to the engine E and the engine mounts M. The housing 20 is provided with a series of slots 40 located around an outer surface 42 of the housing 20. More specifically, the front and back covers 22, 24 are each provided with a portion of each slot 40, though the slot 40 has a gap 41 between the housing covers 22, 24 such that the stator 26 is exposed therebetween. Otherwise, the slot 40 generally runs the length L of the alternator 10, and the slots 40 are arranged around an entire circumference of the outer surface 42 of the housing covers 22, 24. Preferably, the slots 40 are radially positioned every 30 degrees around the outer surface of the housing 20. In this manner, each bracket 30 may be mounted at any point along the slots 40.

However, the preferred manner of securing the brackets 30 to the housing 20 allows the brackets 30 to attach only to the front and back cover 22, 24 portions. More specifically, the front and back covers 22, 24 are secured with the alternator 10 so that a gap 27 is formed therebetween, through which the stator 26 is exposed. The brackets 30, or a portion thereof as will be described below, are inserted into the gap 27 so that the brackets 30 are aligned with the slots 40. At this point, the bracket 30 may be slid into the slot 40 to a desired position.

A variety of brackets 30 corresponding to various orientations for various vehicles is provided, as will be discussed below, and selected from for a particular vehicular installation. The brackets 30 are selectively mounted in the slots 40 so that the alternator 10 may be properly installed to a particular engine E in a particular vehicle. At a front end 44 and a rear end 46 of each slot 40, a wall 48 is formed as a stop so that the bracket 30 is retained in the slot 40.

One form of the bracket 30 is illustrated in FIG. 1 as being a one-piece bracket 50. In this form, the bracket 50 is a unitary structure including two foot portions 52 received in slots 40a and 40b, a riser portion 54, and a bolt port or hole 56. As can be seen in FIG. 9, the slots 40a and 40b are undercut so as to provide receiving channels 60 such that a lower portion 61 of each slot 40a, 40b is larger than an upper portion 62. The lower portion 61 is radially positioned closer to a central axis X of the alternator 10 than the upper portion 62. In addition, the foot portions 52 include a stem 58 and side wings 59 extending outward from the stem 58 and sized to be received with a close-fit within the slots 40a, 40b. In this form, the bracket 50 closely fits or is press-fit into the slots 40 so as to minimize or generally eliminate movement between the bracket 50 and slots 40 so that the alternator 10 is sufficiently secured when the bracket 50 is secured to an engine E. As depicted, a bracket 50a is positioned so as to abut the wall 48 on the back cover 24 at the end of the slot 40, and a bracket 50b is positioned so as to abut the wall 48 on the front cover 22 at the end of the slot 40. By positioning and securing the brackets 50a, 50b in this manner, the mounting of the brackets 50a, 50b provides a small amount of outward tension to further immobilize the brackets 50a, 50b relative to the housing 20.

In a second form, a bracket 70 is provided substantially identical to the bracket 50. That is, the bracket 70 is a modification of the bracket 50 in the sense that the bracket 70 further includes one or more set bores 72. The set bore 72 may receive a set screw 74 for securing the bracket 70 to the housing 20. In one form, the set screw 74 may mate with threads in foot portions 76 and may be driven against an interior surface 78 of a slot 40c such that wings 80 of the foot portions 76 frictionally engage with an upper wall 64 of the channels 60. In another form, the set screw 74 may mate with threads in a slot bore 82 formed in the surface 78 of the slot 40c such that set screw 74 firmly secures the bracket 70 against the surface 78.

In a further modification of the bracket 50, a bracket is provided as a two-piece bracket 90, also utilizing set screws 92. In this form, the bracket 90 includes separate foot portions 94 that are received and positioned in the slots such as slot 40d. Once the foot portions 94 are secured by sliding into the slots 40, the bracket 90 is then positioned on the foot portions 94 and secured thereto by the set screw 92 in, for example, the above-described manners. In addition, the set screws 92 may tighten the bracket 90 and foot portions 94 together so that they clamp to the housing 20.

In the preferred embodiment, FIG. 10 illustrates another form of mounting bracket represented as bracket 100 and having foot portion 102. As can be seen, a slotted portion of the housing 20 is depicted such that the slot 104 has a symmetrical trapezoidal shape. The foot portion 102 is placed in the slot 104, and the bracket 100 is secured to the foot portion 102 by a set screw 106. The foot portion 102 also has a symmetrical trapezoidal shape, but is smaller than the cross-sectional size of the slot 104. Accordingly, the set screw 104 draws the foot portion 102 towards the bracket 100 when tightened, and small gap remains between the foot portion 102 and the bracket 100. That is, side wedges 108 that define the slot 104 are clamped in between the foot portion 102 and the bracket 100. In this manner, the friction generated by the clamping compression between the foot portion 102 and the bracket 100 secures these to the housing 20.

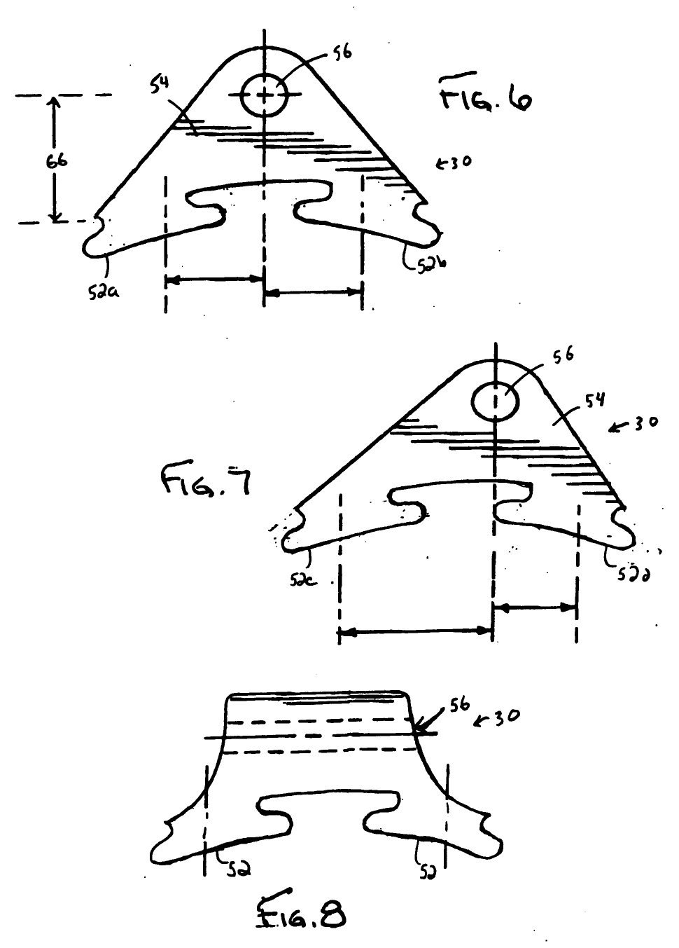

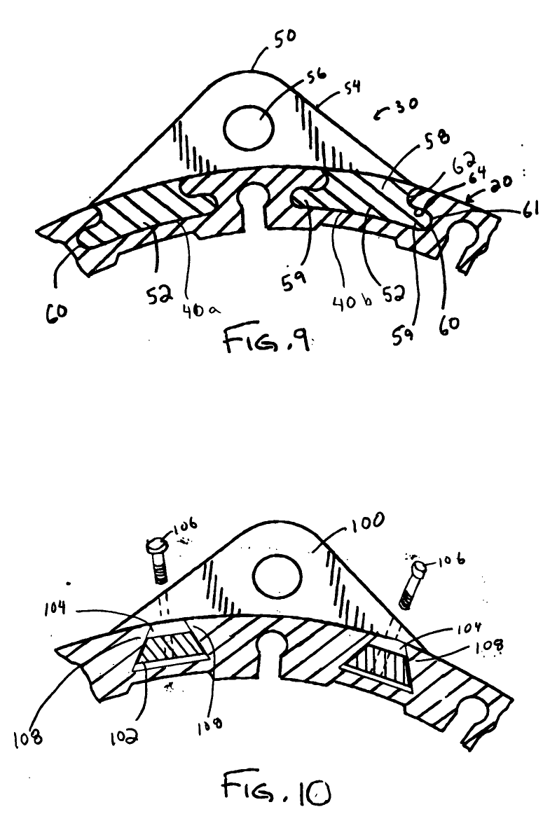

Referring now to FIGS. 6-8, further configurations of the bracket 30 are depicted. As discussed above, the alternator 10 is provided with a variety of brackets 30 so that the brackets 30 are selected to mate with engine mounts. The bolt port 56 is positioned according to the requirements of the vehicle in which it is mounted so that a bolt (not shown) may be inserted in the bolt port 56 to connect the alternator 10 to the engine E. That is, the bolt port 56 of each bracket 30 may positioned on the bracket in a variety of configurations relative to the slots 40 to mate with the engine mounts. For instance, the riser portion 54 has a height 66 selectively provided in the manufacturing of the bracket 30. In addition, FIG. 6 illustrates the riser portion 54 constructed so that the bolt port 56 is positioned midway between two slots foot portions 52a and 52b for securing in adjacent slots 40. Alternatively, the bolt port 56 may be offset between two foot portions 52c and 52d, as is depicted in FIG. 7. In FIGS. 6 and 7, the bolt port 56 is depicted as being generally aligned with longitudinal direction or central axis X of the alternator 10 (see FIG. 1). As a further alternative, the bolt port 56 may be skew relative to the longitudinal direction of the alternator 10, such as being orthogonal to the longitudinal direction, as is depicted in FIG. 8.

As has been stated, the present embodiments depict the alternator housing 20 having slots 40 and the brackets, such as bracket 30, include portions, such as foot portions 52, that are received in the slots. However, any of the described structures may easily be reversed such that the alternator 10 has portions received within slots 40 formed in the brackets 30. Furthermore, any combination of the different forms of the brackets 30 described herein may be provided with a single alternator 10 for mounting on any particular engine, and different facets of each form of bracket 30 may be combined with other facets of another form. Furthermore, kits (not shown) may be provided, such as in retailing the alternator 10, such that the proper brackets 30 for a particular vehicle and engine are provided with the alternator 10 so that a consumer merely purchases the kit for their particular vehicle. Alternatively, the brackets 30 may be sold separately so that a consumer may purchase the brackets 30 necessary to mount the alternator 10 in a manner inconsistent with a particular vehicle's original design, yet consistent with a personalized or customized design. It should further be noted that a portion of the brackets 30 may be pre-set in the slots 40 during manufacturing, such as the foot portions 94 of the two-piece bracket 90. The foot portions 56 of any bracket 30 may be received in adjacent slots 40, or may be received in slots 40 within interposed slots 40 that do not receive a portion of the bracket 30. Furthermore, a bracket 30 may be provided with a single foot portion 56 received in a single slot 40.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. An alternator for use with an internal combustion engine, the alternator comprising:
a rotor;
a stator;
a housing; and
at least one bracket including a unitary receivable portion and a second portion, the bracket being selectively securable to the housing, wherein the housing is provided with a slot for securing for receiving the receivable portion of the bracket therewithin, the slot including at least first and second undercut portions, and the receivable portion of the bracket being securable within the undercut portions.

2. (canceled)

3. The alternator of claim 1 wherein an exterior surface of the housing includes a series of slots for selectively securing the at least one bracket to the housing.

4. The alternator of claim 3 wherein the slots are positioned every 30 degrees around the surface of the housing.

5. The alternator of claim 3 wherein each bracket includes a second receivable portion securable in a slot, the receivable portions being received in two respective slots of the housing.

6. The alternator of claim 5 wherein the receivable portions are received in adjacent slots of the housing.

7. The alternator of claim 1 wherein each slot undercut has an upper portion and a lower portion larger than the upper portion, each receivable portion has a wing portion larger than a stem portion, and the wing portion may be received in the larger, lower portion of the slot.

8. The alternator of claim 7 wherein the bracket portions are integral with the bracket.

9. The alternator of claim 7 wherein the receivable portion is secured to the second portion by a set screw.

10. The alternator of claim 1 wherein each bracket includes a bolt hole for securing the bracket to the engine.

11. The alternator of claim 10 wherein the bolt hole is aligned with a central axis of the alternator.

12. The alternator of claim 1 wherein the bracket and slot are clampingly secured along the slot.

13. The alternator of claim 1 wherein the bracket and slot are press-fit.

14. A kit for installing an alternator used with an internal combustion engine, the kit comprising:
an alternator having a housing;
radially located slots formed in an outer surface of the housing, each slot having a pair of undercuts formed by an upper portion and by, a lower portion larger than the upper portion and positioned closer to a central axis of the alternator;
brackets including a unitary structure receivable in both undercuts of a slot, wherein the brackets may be selectively secured in the slots, and the secured brackets may be secured to mounts provided on the engine for securing the alternator thereto.

15. The kit of claim 14 wherein the brackets includes a set of brackets configured for securing to the engine in a first orientation.

16. The kit of claim 15 wherein the brackets includes at least a second set of brackets configured for securing to a different internal combustion engine in at least a second orientation.

17. A method for installing an alternator used with an internal combustion engine of a vehicle comprising the steps of:
providing an internal combustion engine with mounts for receiving at least one securing bolt;
providing an alternator with a housing;
providing slots on an outer surface of the housing and having undercuts;
selecting at least one bracket with a bolt hole;
inserting a unitary portion of each bracket in at least one of the slots so as to extend generally across the slot and within the undercuts thereof;
securing the bracket to the at least one slot so that the bolt holes are aligned with the mounts of the engine; and
securing bolts in the bolt holes of the brackets and the mounts.

18. The method of claim 17 further including the step of identifying the make and model of the vehicle, and the step of selecting the bracket is based on the make and model.
